(19) United States
(12) Patent Application Publication
(10) Pub. No.: US 2005/0092000 A1
(43) Pub. Date: May 5, 2005

(54) System and method for recycling oil in air conditioner

(75) Inventors: Il-Nahm Hwang, Gyeonggi-Do (KR); Yoon-Been Lee, Seoul (KR); Dong-Jun Yang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/932,099

(22) Filed: Sep. 2, 2004

(30) Foreign Application Priority Data
Nov. 5, 2003 (KR) 78033/2003

(51) Int. Cl. F25B 43/02; G05D 23/32; F25B 31/00

(52) U.S. Cl. 62/193; 62/84; 62/468

(57) ABSTRACT

Disclosed are a system for recycling oil in an air conditioner and a method thereof. The system comprises: an oil recycling line connected between a compressor for compressing a refrigerant and an accumulator for dividing a refrigerant into gas and liquid and thereby supplying the gas refrigerant to the compressor, for recycling oil stored in the accumulator to the compressor; an open/close valve installed at the oil recycling line and opening and closing the oil recycling line; and a control unit for controlling the open/close valve and thereby controlling an oil supply from the accumulator to the compressor. According to this, an oil deficiency of the compressor is prevented and thereby a reliability of the compressor is enhanced.

### BACKGROUND OF THE INVENTION

1. Field of the Invention

The present invention relates to an air conditioner, and more particularly, to a system for recycling oil stored in an accumulator to a compressor and a method thereof.

2. Description of the Conventional Art

FIG. 1 is a construction view of a refrigerating cycle of an air conditioner in accordance with the conventional art.

The conventional air conditioner comprises: an indoor heat exchanger 102 arranged indoors thus to be heat-exchanged with indoor air; an outdoor heat exchanger 104 arranged outdoors thus to be heat-exchanged with outdoor air; an expansion valve 110 installed at a refrigerant pipe 108 that connects the outdoor heat exchanger 104 and the indoor heat exchanger 102, for converting refrigerant gas into a low temperature and a low pressure; compressors 112 and 114 for compressing refrigerant of a low temperature and a low pressure exhausted from the indoor heat exchanger 102 into a high temperature and a high pressure; and accumulators 116 and 118 for dividing refrigerant exhausted from the indoor heat exchanger 102 into gas and liquid and thereby supplying the gas refrigerant to each compressor 112 and 114.

The compressors are composed of a first compressor 112 and a second compressor 114. An oil passage 130 for passing oil so as to uniformly maintain an oil level between the compressors 112 and 114 is installed between the first compressor 112 and the second compressor 114. The oil passage 130 is connected to other compressors by an oil pipe 132 and uniformly maintains an oil level between the compressors at the time of applying a multi-type outdoor unit. A solenoid valve 134 for opening and closing an oil flow passage is mounted at the oil pipe 132. Also, check valves 120 and 122 for preventing refrigerant from backwardly flowing are installed at discharge sides of the first and second compressors 112 and 114.

The accumulators are composed of: a first accumulator 116 connected to the first compressor 112 by a refrigerant pipe 140, for dividing refrigerant sucked through a suction pipe 144 into gas and liquid and thereby supplying the gas refrigerant to the first compressor 112; and a second accumulator 118 connected to the second compressor 114 by a refrigerant pipe 142, for dividing refrigerant sucked through the suction pipe 144 into gas and liquid and thereby supplying the gas refrigerant to the second compressor 114.

As shown in FIG. 2, the first and second accumulators comprise: a case 150 having a certain hermetic space; a suction pipe 144 connected to an upper side of the case 150, for sucking refrigerant; and a discharge pipe 152 inserted to inside of the case 150 from an upper portion of the case 150 and extended upwardly via a lower portion of the case 150, for supplying a gas refrigerant vaporized inside the case 150 to each compressor.

An upper cover 151 is hermetically mounted at the upper side of the case 150, and the suction pipe 144 and the discharge pipe 152 are respectively inserted into the upper cover 151. A lower cover 154 is hermetically mounted at the lower side of the case 150.

Oil contained in the refrigerant introduced through the suction pipe 144 is stored at the lower portion of the case 150, and an oil recycling hole 156 for recycling the oil stored in the case 150 is formed at the discharge pipe 152 positioned at the lower portion of the case 150. Therefore, by a pressure of a refrigerant that flows in the discharge pipe 152, the oil stored in the lower portion of the case 150 is sucked into the oil recycling hole 156 and recycled to each compressor 112 and 114 thereby to perform a lubrication operation of the compressor.

However, in the conventional air conditioner, the discharge pipe 152 is arranged to maintain a certain gap from the bottom surface of the case 150 with consideration of an assembly tolerance that the lower cover 154 is assembled to the lower portion of the case 150.

Therefore, the oil recycling hole 156 formed at the discharge pipe 150 has a certain gap from the bottom surface of the case 150. According to this, the oil having an amount corresponding to the height H from the bottom surface of the case 150 is not recycled to the compressors 112 and 114 but remains at the accumulators 116 and 118, thereby causing an oil deficiency inside the compressors 112 and 114 and thus lowering a reliability of the compressor.

### SUMMARY OF THE INVENTION

Therefore, an object of the present invention is to provide a system for recycling oil in an air conditioner and a method thereof capable of solving an oil deficiency phenomenon inside a compressor and enhancing a reliability of the compressor by recycling oil that remains at a lower portion of an accumulator to the compressor.

To achieve these and other advantages and in accordance with the purpose of the present invention, as embodied and broadly described herein, there is provided a system for recycling oil in an air conditioner comprising: an oil recycling line formed between a compressor for compressing a refrigerant and an accumulator for dividing a refrigerant into gas and liquid and thereby supplying the gas refrigerant to the compressor, for recycling oil stored in the accumulator to the compressor; an open/close valve installed at the oil recycling line, for opening and closing the oil recycling line; and a control unit for controlling the open/close valve and thereby controlling an oil supply from the accumulator to the compressor.

The control unit includes: a first temperature sensor installed at one side of the oil recycling line connected to the compressor, for detecting an oil temperature; a second temperature sensor installed at one side of a suction pipe that supplies a refrigerant to the accumulator, for detecting a temperature of a refrigerant supplied to the accumulator; and a controller for comparing the temperature measured by the first temperature sensor with the temperature measured by the second temperature sensor and opening the open/close valve if the temperature difference is judged to be within a preset value.

To achieve these and other advantages and in accordance with the purpose of the present invention, as embodied and broadly described herein, there is also provided a method for recycling oil in an air conditioner comprising: a first step of judging whether a liquid refrigerant exists inside an accumulator; a second step of opening an open/close valve and recycling oil that remains at a lower portion of the accumulator to a compressor if it is judged as that a liquid refrigerant does not exist inside the accumulator; and a third step of counting an open time of the open/close valve and closing the open/close valve after a preset time lapses.

The first step includes the steps of: detecting a temperature a refrigerant supplied to the accumulator; detecting a temperature of oil stored in the compressor; and comparing a temperature difference between the refrigerant temperature and the oil temperature with a preset value.

In the second step, the open/close valve is opened and thereby the oil recycling line connected between the accumulator and the compressor is opened if the temperature difference is within the preset value.

In the third step, a timer counts an open time of the open/close valve and if the open time is within a preset time, a control unit closes the open/close valve thereby to close the oil recycling line.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a construction view of a refrigerating cycle of an air conditioner in accordance with the conventional art;

FIG. 2 is a sectional view of an accumulator in accordance with the conventional art;

FIG. 3 is a construction view of a refrigerating cycle of an air conditioner according to one embodiment of the present invention;

FIG. 4 is a construction view showing an oil recycling system according to one embodiment of the present invention;

FIG. 5 is a block diagram showing an oil recycling method according to one embodiment of the present invention;

FIG. 6 is a flow chart showing the oil recycling method according to one embodiment of the present invention;

FIG. 7 is a construction view showing an oil recycling system according to another embodiment of the present invention; and

FIG. 8 is a block diagram showing an oil recycling method according to another embodiment of the present invention.

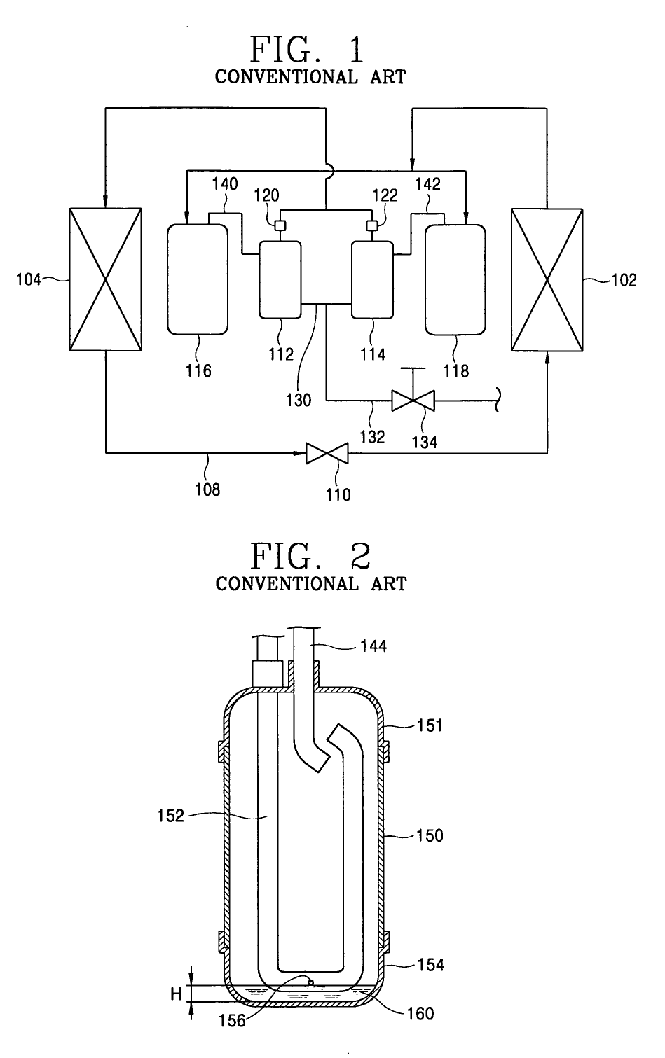

### DETAILED DESCRIPTION OF THE PREFERRED EMBODIMENTS

Reference will now be made in detail to the preferred embodiments of the present invention, examples of which are illustrated in the accompanying drawings.

Hereinafter, preferred embodiments of an oil recycling system in an air conditioner according to the present invention will be explained with reference to the attached drawings.

Even if a plurality of preferred embodiments of the oil recycling system in an air conditioner according to the present invention may exist, the most preferred embodiment will be explained hereinafter.

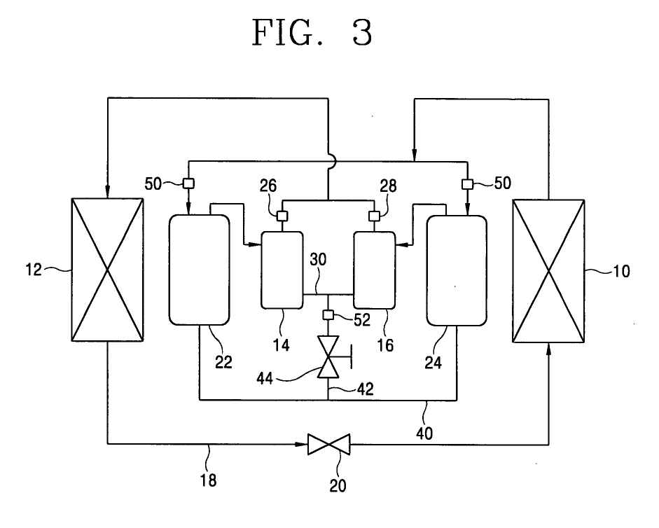

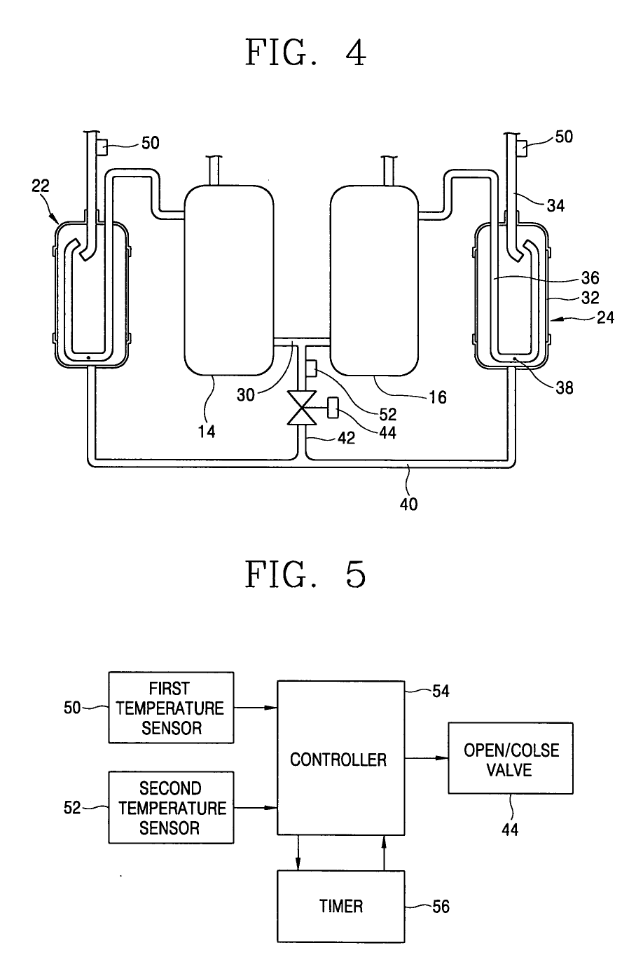

FIG. 3 is a construction view of a refrigerating cycle of an air conditioner according to one embodiment of the present invention, and FIG. 4 is a construction view showing an oil recycling system according to one embodiment of the present invention.

An air conditioner according to one embodiment of the present invention comprises: an indoor heat exchanger 10 arranged indoors thus to be heat-exchanged with indoor air; an outdoor heat exchanger 12 arranged outdoors thus to be heat-exchanged with outdoor air; an expansion valve 20 installed at a refrigerant pipe 18 that connects the outdoor heat exchanger 12 and the indoor heat exchanger 10, for converting refrigerant gas into a low temperature and a low pressure; compressors 14 and 16 for compressing the refrigerant of a low temperature and a low pressure and converting into a high temperature and a high pressure; accumulators 22 and 24 for dividing refrigerant into gas and liquid and thereby supplying the gas refrigerant to each compressor 14 and 16; and an oil recycling system for recycling oil remaining at a lower portion of the accumulators 22 and 24 to the compressors 14 and 16.

The compressors are composed of the first compressor 14 and the second compressor 16. An oil passage 30 for uniformly maintaining an oil level between the compressors is installed between the first compressor 14 and the second compressor 16.

Also, check valves 26 and 28 for preventing refrigerant from backwardly flowing are respectively installed at discharge sides of the first and second compressors 14 and 16.

The accumulators are composed of the first accumulator 22 for supplying gas refrigerant to the first compressor 14, and the second accumulator 24 for supplying gas refrigerant to the second compressor 16.

The first and second accumulators 22 and 24 comprise: a case 32 having a refrigerant vaporization space and storing oil introduced with being included in refrigerant at a lower portion thereof; a suction pipe 34 inserted into an upper side of the case 32 and sucking refrigerant; and a discharge pipe 36 connected to the upper side of the case 32 and supplying a gas refrigerant vaporized inside the case 32 to each compressor 14 and 16.

The discharge pipe 36 is inserted to inside of the case 32 from an upper portion of the case 32 and extended upwardly via a lower portion of the case 32. An oil recycling hole 38 for recycling oil stored in the case 32 to the compressors 14 and 16 is formed at the discharge pipe 36 positioned at the lower portion of the case 32.

Therefore, by a pressure of a refrigerant that flows in the discharge pipe 36, the oil stored in the lower portion of the case 32 is sucked into the oil recycling hole 38 and recycled to each compressor 14 and 16 thereby to perform a lubrication operation of the compressor.

The oil recycling system is for recycling oil that is not recycled through the oil recycling hole 38 but remains at the lower portion of the accumulator to the compressors 14 and 16. The oil recycling system includes: an oil recycling line 40 connected to the accumulators 22 and 24 for recycling oil that remains at the lower portion of the accumulators 22 and 24; a connection line 42 connected between the oil recycling line 40 and the oil passage 30 connected between the compressors 14 and 16; an open/close valve 44 installed at the connection line 42, for opening and closing the connection line 42; and a control unit for controlling the open/close valve 44 and thereby controlling an oil supply to the compressors 14 and 16.

The open/close valve 44 is preferably constructed as a solenoid valve for opening the connection line 42 when a power source is applied and for closing the connection line 42 when the power source is shielded.

The control unit, as shown in FIG. 5, includes: a first temperature sensor 50 installed at the suction pipe 34 of the accumulators 22 and 24, for detecting a temperature of a refrigerant supplied to the accumulators 22 and 24; a second temperature sensor 52 installed at the oil passage 30, for detecting a temperature of oil stored in the compressors 14 and 16; and a controller 54 for comparing the temperature measured by the first temperature sensor 50 with the temperature measured by the second temperature sensor 52 and operating the open/close valve 44 if the temperature difference is judged to be within a preset value.

The controller 54 is provided with a timer 56 for counting the time that the open/close valve 44 has been operated and shielding a power to the open/close valve 44 when the time reaches to a preset time thus closing the connection line 42.

Operation of the oil recycling system in an air conditioner according to the present invention will be explained as follows.

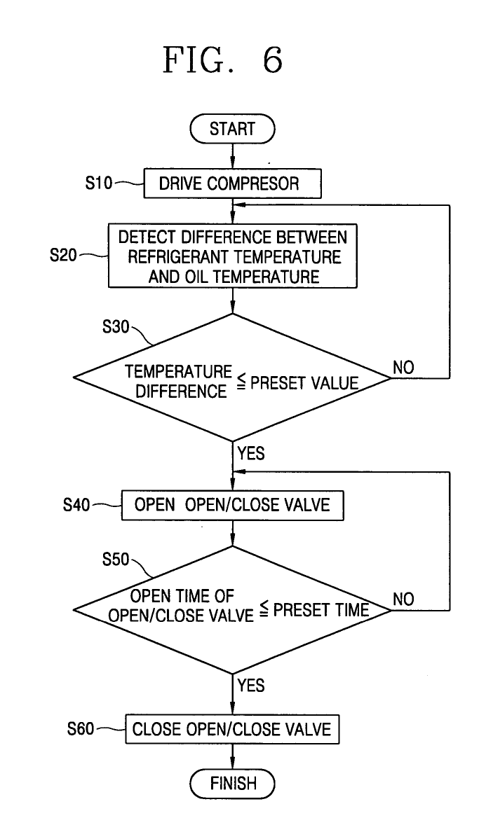

FIG. 6 is a flow chart showing an oil recycling method in an air conditioner according to the present invention.

When the compressors 14 and 16 are driven, a refrigerant is circulated, the indoor heat exchanger 10 is heat-exchanged with indoor air, and the outdoor heat exchanger 12 is heat-exchanged with outdoor air (S10).

When the refrigerating cycle is operated, oil stored in the compressors 14 and 16 is circulated with refrigerant thus to be sucked into the accumulators 22 and 24. The oil sucked into the accumulators 22 and 24 is recycled to the compressors 14 and 16 through the oil recycling hole 38 formed at the discharge pipe 36.

At this time, oil that is not recycled to the oil recycling hole 38 but remains at the lower portion of the case 32 of the accumulators 22 and 24 is recycled to the compressors 14 and 16 by the oil recycling system.

The oil recycling system detects a temperature difference between a temperature of the refrigerant supplied to the accumulators 22 and 24 and a temperature of the oil stored in the compressors 14 and 16, and thus compares the temperature difference with a preset value (S20, S30).

That is, the oil recycling system detects the refrigerant temperature by the first temperature sensor 50 installed at the suction pipe 34 thereby to apply to the controller 54, and detects the oil temperature by the second temperature sensor 52 thereby to apply to the controller 54. According to this, the controller 54 detects a temperature difference between the refrigerant temperature and the oil temperature and compares the temperature difference with a preset value.

If the temperature difference is judged to be within a preset value T, the open/close valve is operated thus to open the connection line 42 and the oil remaining at the accumulators 22 and 24 are recycled to the compressors 14 and 16 (S40).

That is, if the temperature difference is judged to be within the preset value T, the controller 54 applies a power to the open/close valve 44 thus to open the open/close valve 44 and thereby the connection line 42 is opened. According to this, the oil recycling line 40 connected to the lower portion of the accumulators 22 and 24 is connected to the oil passage 30 connected between the compressors 14 and 16, and the oil remaining at the accumulators 22 and 24 passes through the oil recycling line, the connection line 42, and the oil passage 30 thereby to be recycled into the compressors 14 and 16.

The preset value T is set so that the refrigerant temperature and the oil temperature can be similar to each other. If liquid refrigerant does not exist at the accumulators 22 and 24, the open/close valve 44 is operated.

In case that the refrigerant supplied to the accumulators 22 and 24 through the suction pipe 34 is a refrigerant that gas and liquid are mixed, the refrigerant temperature is low. Also, in case that the mixed refrigerant becomes a gas refrigerant after being completely vaporized, the temperature is high. Generally, the gas refrigerant temperature and the oil temperature of the compressor are similar to each other. Therefore, if a refrigerant temperature and an oil temperature are similar to each other, it is judged as that a liquid refrigerant does not exist in the accumulators 22 and 24.

In case that a refrigerant that gas and liquid are mixed is supplied to the accumulator, liquid refrigerant exists inside the accumulator thus to cause the liquid refrigerant to be introduced into the compressors 14 and 16 through the oil recycling line 40. To prevent this, the open/close valve 44 is set to be opened only under a condition that refrigerant is completely vaporized in the accumulators 22 and 24 and thus liquid refrigerant does not exist, thereby recycling oil that remains at the accumulators 22 and 24 to the compressors 14 and 16.

Operation time of the open/close valve 44 is counted, and if the operation time reaches a preset time, the open/close valve 44 is closed thus to close the connection line 42 and thereby to stop an oil recycling operation to the compressors 14 and 16 (S50, S60).

That is, if the operation time of the open/close valve 44 counted by the timer 56 reaches a preset time, the controller 54 shields a power applied to the open/close valve 44 thereby to stop the oil recycling operation.

At this time, the preset time can be varied according to a capacity of the accumulator and the compressor, and is preferably set as approximately one minute.

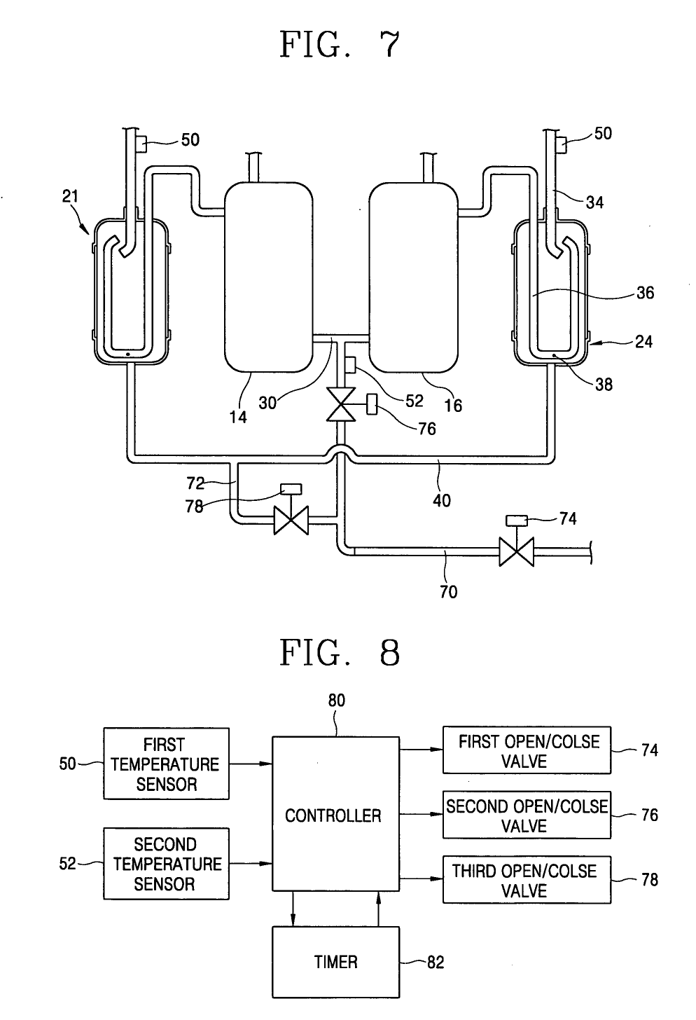

FIG. 7 is a construction view showing an oil recycling system according to another embodiment of the present invention.

In case that the oil recycling system according to another embodiment of the present invention is applied to a multi-type outdoor unit, the oil recycling system recycles oil with uniformly maintaining an oil level between compressors by being connected to the compressors of outdoor units by an oil pipe 70.

That is, the oil recycling system according to another embodiment of the present invention includes: an oil recycling line 40 connected between lower portions of the accumulators 22 and 24; an oil passage 30 connected between the compressors 14 and 16; an oil pipe 70 connected to the oil passage 30 and compressors of other outdoor units; a connection line 72 connected between the oil pipe 70 and the oil recycling line 40; a first open/close valve 74 installed at the oil pipe 70 for opening and closing the oil pipe 70 for a uniform driving between the outdoor units; a second open/close valve 76 installed at the oil passage 30 for opening and closing the oil passage 30; a third open/close valve 78 installed at the connection line 72 for opening and closing the connection line 72; and a control unit for controlling the first, second, and third valves 74, 76, and 78.

As shown in FIG. 8, the control unit includes: a first temperature sensor 50 installed at the suction pipe 34 of the accumulators 22 and 24 and detecting a temperature of a refrigerant_Supplied to the accumulators 22 and 24; a second temperature sensor 52 installed at the oil passage 30 and detecting a temperature of oil stored in the compressors 14 and 16; and a controller 80 for comparing the temperature measured by the first temperature sensor 50 with the temperature measured by the second temperature sensor 52 and selectively operating the first, second, and third open/close valves 74, 76, and 78 if the temperature difference is judged to be within a preset value.

A timer 82 is mounted at the controller 80. The timer 82 counts operation time of the second and third open/close valves 76 and 78 and shields a power to the second and third open/close valves 76 and 78 if the counted operation time reaches a preset time thus close the connection line 72.

Operation of the oil recycling system according to another embodiment of the present invention will be explained. If the temperature difference between the temperature applied from the first temperature sensor 50 and the temperature applied from the second temperature sensor 52 is within a preset value, the controller 80 closes the first open/close valve 74 and opens the second and third open/close valves 76 and 78. According to this, oil that remains at the accumulators 22 and 24 is recycled to the compressors 14 and 16 through the oil recycling line 40, the connection line 72, and the oil passage 30.

Also, if an open time of the second and third open/close valves 76 and 78 reaches a preset time, the controller 80 closes the second and third open/close valves 76 and 78 and opens the first open/close valve 74 for a uniform driving.

As aforementioned, according to the oil recycling system in an air conditioner according to the present invention, the open/close valve is opened when liquid refrigerant does not exist inside the accumulator thus to recycle oil that remains at the lower portion of the accumulator to the compressor, thereby preventing an oil deficiency of the compressor and enhancing the reliability of the compressor.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A system for recycling oil in an air conditioner comprising:
an oil recycling line connected between a compressor for compressing a refrigerant and an accumulator for dividing a refrigerant into gas and liquid and thereby supplying the gas refrigerant to the compressor, for recycling oil stored in the accumulator to the compressor;
an open/close valve installed at the oil recycling line and opening and closing the oil recycling line; and
a control unit for controlling the open/close valve and thereby controlling an oil supply from the accumulator to the compressor.

2. The system of claim 1, wherein a plurality of the compressors are provided, each compressor is connected by an oil passage, and the oil recycling line is connected between the oil passage and the plurality of accumulators.

3. The system of claim 1, wherein the open/close valve is a solenoid valve that is opened and closed when a power source is applied.

4. The system of claim 1, wherein the control unit includes:
a first temperature sensor installed at one side of the oil recycling line connected to the compressor and detecting an oil temperature;
a second temperature sensor installed at one side of a suction pipe that supplies a refrigerant to the accumulator and detecting a temperature of a refrigerant supplied to the accumulator; and
a controller for comparing the temperature measured by the first temperature sensor with the temperature measured by the second temperature sensor and opening the open/close valve if the temperature difference is judged to be within a preset value.

5. The system of claim 4, wherein the control unit further includes a timer for counting an open time of the open/close valve and stopping a driving of the open/close valve when the counted open time reaches a preset time.

6. A system for recycling oil in an air conditioner comprising:
an oil passage connected between a plurality of compressors and uniformly maintaining an oil level between each compressor;
an oil pipe connected between the oil passage and other outdoor units;
an oil recycling line connected between a plurality of accumulators;
a connection line connected between the oil passage and the oil recycling line;
a first open/close valve installed at the oil passage and opening and closing the oil passage;
a second open/close valve installed at one side of the connection line and opening and closing the connection line;
a third open/close valve for opening and closing the oil pipe; and
a control unit for selectively controlling the first, second, and third valves.

7. The system of claim 6, wherein the first, second, and third open/close valves are solenoid valves that are opened and closed when a power source is applied thereto.

8. The system of claim 6, wherein the control unit includes:
a first temperature sensor installed at the oil passage and detecting a temperature of oil stored in each compressor;
a second temperature sensor respectively installed at suction pipes of the accumulators and detecting a temperature of a refrigerant supplied to the accumulator; and
a controller for controlling an operation of the first, second, and third open/close valves according to signals applied from the first and second temperature sensors.

9. The system of claim 8, wherein the controller is provided with a timer for counting an open time of the open/close valve and closing the second and third open/close valves when the counted open time reaches a preset time.

10. A method for recycling oil in an air conditioner comprising:
a first step of judging whether a liquid refrigerant exists inside an accumulator;
a second step of opening an open/close valve and recycling oil that remains at a lower portion of the accumulator to a compressor if it is judged that a liquid refrigerant does not exist inside the accumulator; and
a third step of counting an open time of the open/close valve and closing the open/close valve after a preset time lapses.

11. The method of claim 10, wherein the first step includes the steps of:
detecting a temperature a refrigerant supplied to the accumulator;
detecting a temperature of oil stored in the compressor; and
comparing a temperature difference between the refrigerant temperature and the oil temperature with a preset value.

12. The method of claim 11, wherein the preset value is set so that the refrigerant temperature and the oil temperature can be similar to each other.

13. The method of claim 10, wherein in the second step, when the temperature difference is judged to be within the preset value, the open/close valve is opened and thereby the oil recycling line connected between the accumulator and the compressor is opened.

14. The method of claim 10, wherein in the third step, when an open time of the open/close valve counted by a timer is within a preset time, a controller closes the open/close valve thus to close the oil recycling line.
